(19) United States
(12) Patent Application Publication
(10) Pub. No.: US 2011/0169225 A1
(43) Pub. Date: Jul. 14, 2011

(54) MECHANICAL SEAL ASSEMBLY WITH INTEGRATED HEAT TRANSFER UNIT

(75) Inventors: Andreas Winkler, Wolfrastshausen (DE); Joachim Otschik, Aschaffenburg (DE); Rudolf Schicktanz, Geretsried (DE)

(73) Assignee: Eagle Burgmann Germany GmbH & Co. KG, Wolfratshausen (DE)

(21) Appl. No.: 12/737,134

(22) PCT Filed: Jun. 10, 2009
(86) PCT No.: PCT/EP2009/004201

§ 371 Date: Feb. 7, 2011

(30) Foreign Application Priority Data
Jun. 18, 2008 (DE) 20 2008 008 158.0

(51) Int. Cl. F16J 15/34

(52) U.S. Cl. 277/408

(57) ABSTRACT

The invention relates to a mechanical seal assembly, comprising a first stationary seal ring (2), a second rotating seal ring (3) which rotates together with a rotating component (4), wherein the seal rings (2, 3) have sliding surfaces opposite of each other, which delimit a seal gap (5) between each other, wherein the stationary seal ring (2) comprises an integrated heat transfer unit disposed in an interior region (2b) of the stationary seal ring (2), and the stationary seal ring comprises an inlet opening (12) for feeding a coolant and an outlet opening (13) for discharging the coolant, wherein the coolant flows through the interior region (2b) of the seal ring from the inlet opening (12) to the outlet opening (13).

The invention relates to a mechanical seal assembly according to the preamble of claim 1, which comprises an integrated heat transfer unit.

Mechanical seal assemblies of different embodiments are known from the state of the art. During operation, relatively high temperatures may occur at the mechanical seal. Said high temperatures are caused i. a. due to the high temperatures of the medium to be sealed, e.g. in case of hot water applications or when used in refinery or petrochemical industry. Due to the high temperature of the medium to be sealed, the components of the mechanical seal may also assume high temperatures. In this context, distortions at the sliding surfaces of the seal rings may occur. This results in particular in restrictions of the application fields of mechanical seals, in particular when hot media are used.

It is an object of the present invention to provide a mechanical seal assembly which enables an expansion of the application fields of the mechanical seal assembly also upon high temperatures while having a simple structure and being manufactured easily and at low costs.

This object is solved by a mechanical seal assembly including the features of claim 1. The sub-claims show preferred further developments of the invention.

The inventive mechanical seal assembly has the advantage that it enables an enhanced heat dissipation by providing a heat transfer unit integrated into the seal ring. According to the invention, it is not required to use large amounts of coolants, but the heat occurring at the mechanical seal can be dissipated directly in the vicinity of the source thereof while using a reduced coolant amount. For this purpose, an inlet opening for feeding the coolant and an outlet opening for discharging the coolant are provided at the stationary seal ring. The integrated heat transfer unit is arranged in an interior region of the stationary seal ring and connects the inlet opening to the outlet opening. Consequently, the temperature at the mechanical seal, in particular directly at a sealing gap between the sliding surfaces of the seal rings, can be reduced effectively according to the invention, such that, in total, an increased service life and also enhanced running characteristics of the mechanical seal assembly can be achieved. Also a heat possibly generated by friction between the two seal rings can be dissipated directly and fast. According to the invention, it is herewith also possible that a possibly existing dry running condition of the mechanical seal assembly may occur over a longer period of time due to the efficient heat dissipation by means of the heat transfer unit integrated into the stationary seal ring. Therewith, the inventive mechanical seal assembly also offers enhanced emergency operation properties.

It is particularly preferred that the integrated heat transfer unit comprises a porous interior structure which is arranged in the interior region of the stationary seal ring. The porous interior structure comprises a plurality of interconnected pores through which the coolant may flow. Since the porous interior structure is disposed in the complete interior space of the stationary seal ring, the coolant may also flow through the complete seal ring such that an efficient and constant cooling can be achieved.

Preferably, the porous interior structure forms a complete interior region of the stationary seal ring, wherein the inner region is delimited by a boundary having a preferably constant thickness.

Preferably, the porous interior structure is made of silicon carbide. For manufacturing the silicon carbide, the interior structure is at first produced by a PU foam which is then converted into carbon at high temperatures and subsequently becomes a silicon carbide reaction-bonded by enrichment with liquid silicon. This results in an interior region having pores with substantially equal size, wherein adjacent pores are respectively connected to each other.

It is further preferred that the boundary of the stationary seal ring is also made of silicon carbide.

In order to enable a constant flow of the coolant through the complete stationary seal ring, the inlet opening is preferably arranged in an angle of 180° with respect to the outlet opening. Therewith, it is enabled that the coolant, starting from the inlet opening, flows along both halves of the stationary seal ring toward the outlet opening. Preferably, a diameter of the inlet opening is equal to a diameter of the outlet opening in this case.

It is further preferred that the stationary seal ring has a rectangular cross-section and that the porous interior region also has a rectangular cross-section constantly along its periphery.

In order to guarantee that the complete width of the stationary seal ring is passed by the coolant, a diameter of the inlet opening preferably amounts to approx. one third or more of a width of the interior region of the stationary seal ring.

Preferably, water or, as an alternative, a sealing agent of the mechanical seal assembly is used as the coolant.

The inventive mechanical seal assembly is in particular used in hot water applications, in refineries or petrochemical industry, or in critical applications, e.g. in rooms to be protected against explosions. The inventive mechanical seal assembly may preferably also be used in multiple seals in which a rinsing and cooling is preformed directly with the flushing agent or the sealing agent.

In the following, a preferred embodiment of the invention is explained in detail with reference to the accompanying drawing, in which

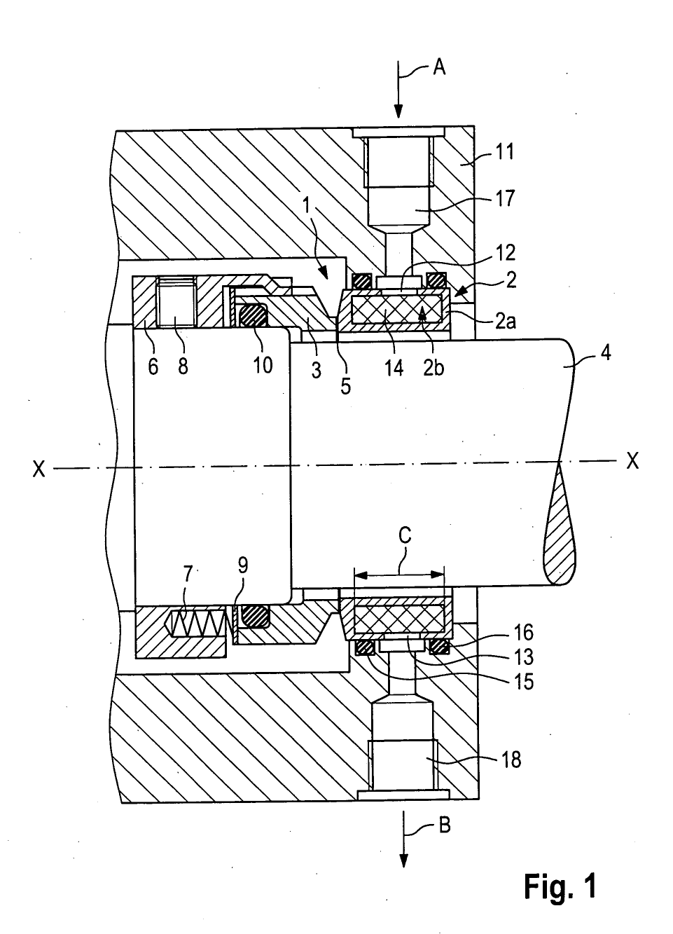

FIG. 1 shows a schematic sectional view of a mechanical seal assembly according to a preferred embodiment of the invention.

FIG. 1 schematically shows a sectional view of a mechanical seal assembly 1. As shown in FIG. 1, the mechanical seal assembly 1 comprises a stationary seal ring 2 arranged at a housing component 11 and a rotating seal ring 3 arranged at a rotating shaft 4 and rotating about a rotary axis X-X together with the shaft 4. The rotating seal ring 3 is fixed to the rotating shaft 4 by means of a fixing device 6. The fixing device 6 is attached to the shaft 4 by means of a screwing member 8, e.g. a worm screw. Further, one or more spring members 7 is/are arranged in the fixing device 6, which apply a biasing force on the rotating seal ring 3 in an axial direction of the shaft through a thrust ring disc 9. The rotating seal ring 3 is further sealed at the shaft 4 by a first O-ring 10.

During operation, a circumferential sealing gap 5 is maintained between the stationary seal ring 2 and the rotating seal ring 3, wherein a sealing between the two chambers is obtained therewith in a known manner.

As is further discernible from FIG. 1, the stationary seal ring 2 is structured such that it comprises an outer boundary 2a and an interior region 2b surrounded by the boundary 2a and having a rectangular cross-section. The interior region 2b is designed as an integrated heat transfer unit and is formed by a plurality of individual pores 14 which are respectively connected to adjacent pores. Therewith, the interior region 2b is formed as a porous interior structure through which a coolant can flow. For this purpose, an inlet opening 12 and an outlet opening 13 are formed in the stationary seal ring 2. The inlet opening 12 communicates with a supply bore 17 provided in the housing component 11 and the outlet opening 13 communicates with a discharge bore 18. The stationary seal ring 2 is sealed against the housing component 11 by second and third O-rings 15, 16.

As indicated by arrow A in FIG. 1, the coolant is fed through the supply bore 17 and the inlet opening 12 into the porous interior region 2b of the stationary seal ring 2. Since the pores 14 are formed in the complete interior region 2b of the stationary seal ring 2, the pores 14 enable a connection between the inlet opening 12 and the outlet opening 13, through which the supplied coolant may flow. Since the inlet opening 12 and the outlet opening 13 are opposed by 180°, the coolant can flow through both ring halves of the stationary seal ring 2 toward the outlet opening 13. The coolant is then discharged from the outlet opening 13 through the discharge bore 18 (arrow B). While flowing through the stationary seal ring 2, the coolant may absorb the heat and thus enable a temperature reduction directly at the stationary seal ring 2 and in particular at the sealing gap 5. Since a diameter of the inlet opening 12 and the outlet opening 13 respectively has approx. one third of a width C of the interior region 2b, it is secured that a sufficient amount of coolant also flows at the inner boundary 2a of the stationary seal ring 2.

According to the invention, a heat transfer unit integrated into the stationary seal ring 2 is thus provided, which enables a direct dissipation of heat in the region of the sealing gap 5. The plurality of pores 14 in the interior region 2b of the stationary seal ring 2 therewith provides a micro heat transfer unit, such that in particular distortions of the sliding surfaces of the seal rings 2, 3 are avoided. By selecting a supply temperature of the coolant, a defined temperature can be easily adjusted in the sealing gap 5, wherein in particular also a temperature of the stationary seal ring 2 can be maintained at the temperature level of the coolant. According to the invention, a faster and considerably enhanced dissipation of heat, either generated by friction and/or by the product to be sealed, can be achieved. Therewith, the service life of the mechanical seal assembly can be increased considerably, and in addition, enhanced emergency operation properties of the mechanical seal assembly, e.g. in case of dry running conditions resulting in increased friction and accordingly increased heat, can be enabled due to the enhanced heat dissipation in the region of the sealing gap. The inventive mechanical seal assembly is preferably used in applications with higher temperatures or bad lubrication characteristics at the mechanical seal. Due to the heat transfer unit integrated into the seal ring 2, it is also possible to scale up an upper temperature limit in hot water applications. Simultaneously, the integrated heat transfer unit can be provided at very low costs. Due to the efficient heat transfer through the porous interior region 2b and a relatively thin wall thickness of the boundary 2a, the amount of coolant can be considerably reduced compared to the state of the art, such that this results also in reduced costs for the coolant. Summarizing the above, the temperature range of applications for the inventive mechanical seal assembly can be enlarged.

1. A mechanical seal assembly, comprising:
a first stationary seal ring, and
a second rotating seal ring which rotates together with a rotating component, wherein the seal rings have mutually opposing sliding surfaces which delimit a seal gap between them, wherein, the stationary seal ring comprises an integrated heat transfer unit disposed in an interior region of the stationary seal ring and the stationary seal ring comprises an inlet opening for feeding a coolant and an outlet opening for discharging the coolant, wherein the coolant flows through the interior region of the seal ring from the inlet opening to the outlet opening.

2. The mechanical seal assembly of claim 1, wherein the heat transfer unit integrated into the stationary seal ring has a porous interior structure including a plurality of interconnected pores.

3. The mechanical seal assembly of claim 2, wherein the porous interior structure is formed in the complete interior region of the stationary seal ring and that the interior region is surrounded by a boundary having in particular a constant thickness.

4. The mechanical seal assembly of claim 2, wherein the porous interior structure is made of silicon carbide.

5. The mechanical seal assembly of claim 3, wherein the boundary is formed of silicon carbide.

6. The mechanical seal assembly of claim 1, wherein the inlet opening is arranged in an angle of 180° with respect to the outlet opening.

7. The mechanical seal assembly of claim 1, wherein a diameter of the inlet opening is equal to a diameter of the outlet opening.

8. The mechanical seal assembly of claim 1, wherein the interior region housing the heat transfer unit has a rectangular cross-section.

9. The mechanical seal assembly of claim 1, wherein the interior region housing the heat transfer unit has a rectangular cross section.
